(19) United States
(12) Patent Application Publication
(10) Pub. No.: US 2015/0379161 A1
(43) Pub. Date: Dec. 31, 2015

(54) SYSTEMS AND METHODS FOR NESTING IRREGULAR PART SHAPES ON A MATERIAL RESOURCE

(71) Applicant: GM GLOBAL TECHNOLOGY OPERATIONS LLC, Detroit, MI (US)

(72) Inventor: DONALD R. JONES, ROYAL OAK, MI (US)

(21) Appl. No.: 14/318,267

(22) Filed: Jun. 27, 2014

(51) Int. Cl. G06F 17/50

(52) U.S. Cl. CPC G06F 17/50

(57) ABSTRACT

A method for nesting a plurality of parts on to a material resource includes approximating each of the parts as the union of a set of inscribed circles, determining an optimal nest of the approximated parts on the material resource, improving the approximation of the parts by adding additional inscribed circles based on overlap of the actual (non-approximated) parts in the nest, and iterating the last two steps until the nest solution is optimal within a predefined tolerance.

### TECHNICAL FIELD

The technical field generally relates to part nesting, and more particularly relates to the automated nesting of irregular, non-convex shapes on a material resource to minimize waste when: (i) the parts can be arranged using both translations and arbitrary rotations and (ii), the goal is to find an exact, guaranteed-optimal solution.

### BACKGROUND

It is often desirable to utilize a material resource, such as a roll of cloth, to cut out parts in a way that is efficient and reduces waste (e.g., to use the least amount of a material resource for a given set of parts, or cut out the greatest number of parts from a given material resource). This “nesting” problem is a relatively difficult task for humans, but is also extremely challenging to computer-implemented nesting systems, which often struggle to match the performance of their human counterparts.

A common element in nesting problems is the requirement that the shapes must be arranged so they do not overlap. Even though the overlap area of two non-convex polygons can be computed numerically, there is no simple closed-form expression for this area. This fact has made it difficult to develop exact algorithms (i.e., those that can provide guaranteed-optimal solutions), because essentially all exact methods in nonlinear global optimization exploit properties of explicit, closed-form problem structure. As a result, few exact algorithms have been developed, and those that exist are usually limited to the special case in which the parts can be arranged via horizontal and vertical translations, but cannot be rotated (or rotation is limited to a few angles). Moreover, existing exact methods are very limited in the number of parts that can be nested.

Accordingly, it is desirable to provide improved methods for nesting irregular shapes on material resource. Additional desirable features and characteristics of the present invention will become apparent from the subsequent detailed description and the appended claims, taken in conjunction with the accompanying drawings and the foregoing technical field and background.

### SUMMARY

A method of nesting a plurality of parts on to a material resource in accordance with one embodiment generally includes: approximating each of the parts as the union of a set of inscribed circles; determining, with a processor, an optimal nesting of the approximated parts on the material resource; improving the approximation of the parts by adding additional inscribed circles based on overlap of the actual (non-approximated) parts in the nest; and iteratively performing the previous two steps until the nest solution is optimal within a predefined tolerance.

A system for nesting a plurality of parts on to a material resource in accordance with one embodiment includes: an initial approximation module configured to approximate each of the parts as the union of a set of inscribed circles; a nest length optimization module, including a processor, configured to determine a nest length associated with the optimal nesting of the approximated parts on the material resource; an iterative refinement module configured to determine if the original (non-approximated parts) overlap in the nest and, if so, refine the inscribed-circle approximation by adding new inscribed circles based on overlap of the parts; and a convergence assessment module that computes a metric used to determine if the nest is optimal within a predefined tolerance.

### DESCRIPTION OF THE DRAWINGS

The exemplary embodiments will hereinafter be described in conjunction with the following drawing figures, wherein like numerals denote like elements, and wherein:

FIG. 1 is a conceptual overview of a material resource in accordance with an exemplary embodiment.

FIG. 2 is a conceptual overview of a plurality of exemplary parts to be nested onto the material resource of FIG. 1.

FIG. 3 is flow chart depicting a method in accordance with one embodiment.

FIGS. 4, 5, and 6 depict the parts of FIG. 2 including inscribed circles in accordance with various embodiments.

FIG. 7 depicts overlap of parts on a material resource in accordance with an exemplary embodiment.

FIG. 8 depicts the addition of a circle within two overlapping parts in accordance with an exemplary embodiment.

FIG. 9 depicts a finished nesting of non-convex parts in accordance with another exemplary embodiment.

FIG. 10 is a flow chart illustrating an exemplary method for inscribing circles in accordance with one embodiment.

FIGS. 11-16 depict an exemplary part as circles are sequentially inscribed therein in accordance with the method depicted in FIG. 10.

FIG. 17 illustrates a metric applied to part penetration in accordance with an exemplary embodiment.

FIGS. 18 and 19 illustrate components of a nesting system in accordance with one embodiment.

FIGS. 20 and 21 depict exemplary nesting arrangements with different nest lengths.

### DETAILED DESCRIPTION

The subject matter described herein generally relates to an efficient method for optimally nesting parts within a material resource by approximating each of the parts as the union of a set of inscribed circles and then iteratively adding inscribed circles until certain criteria have been met. That is, rather than directly determining whether the actual shapes would overlap under any particular nesting, the inscribed circles themselves are analyzed for overlap. Because the approximated parts are smaller than (and subsets of) the original parts, enforcing non-overlap of the approximated parts is less restrictive than enforcing non-overlap of the parts themselves. In this sense, the approximated problem is easier and is a “relaxation” of the original problem. The key benefit of considering this relaxed problem is that it can be solved exactly. By iteratively adding additional circles to improve the approximation, one can eventually enforce the non-overlap of the parts themselves and converge.

The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

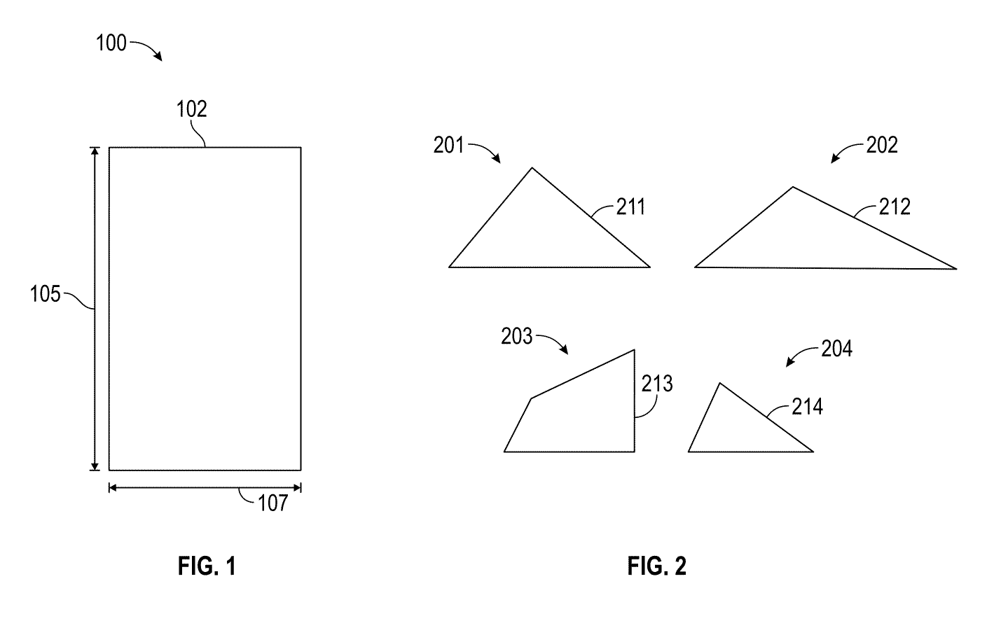

Referring now to FIGS. 1 and 2, an exemplary nesting method will now be described in conjunction with a relatively simplified example as shown. Specifically, FIG. 1 is a conceptual overview of a material resource 100, here a sheet of fabric of fixed width 105 and variable length 107, and FIG. 2 is a conceptual overview of a plurality of exemplary parts 201-204 to be nested on to (or “mapped on to”) material resource 100 while minimizing waste, e.g., minimizing the length 107 of material resource 100 used to nest parts 201-204. For example, referring to the nestings of parts 201-204 depicted in FIGS. 20 and 21, it can be seen the nest length L of the nesting depicted in FIG. 20 (for a given width W) is less than that that of the nesting depicted in FIG. 21. The shaded regions in FIG. 21 thus represent “waste” material resulting from the non-optimal nature of the nesting.

Referring again to FIG. 1, it will be appreciated that the size and shape of parts 201-204 and material resource 100 are not intended to be limiting in any way. That is, while material resource 100 is depicted as having a simple rectangular shape 102, in any particular application material resource 100 might have a wide variety of polygonal shapes. Similarly, while parts 201-204 are illustrated as having corresponding convex polygonal shapes 211-214 (i.e., triangles 211, 212, and 214, and quadrilateral 213), parts 201-204 may have a variety of polygonal shapes, both convex and non-convex. In fact, methods in accordance with the present embodiments are particularly useful in efficiently determining the efficient mapping of irregular and non-convex shapes.

Furthermore, while material resource 100 and parts 201-204 are depicted as two-dimensional objects in the plane, it will be appreciated that the actual, physical material resource (e.g., a sheet of leather and the parts to be cut out of it) will generally be three dimensional objects having a constant or varying thickness. Note, however, that while the actual roll of cloth or leather hide associated with material resource 100 will have a thickness or third dimension, for the purpose of nesting only the two-dimensional planar shape is relevant. In the interest of brevity, the actual two-dimensional geometric representation of material resource 100 (e.g., as a polygon stored in a suitable data structure) may itself be referred to as the “material resource,” and the corresponding two-dimensional geometric representations of parts 201-204 may themselves be referred to as “parts.” That is, a person of ordinary skill in the art will recognize the distinction between the actual material resource 100 (e.g., a sheet of linen) and the mathematical representation of that object (e.g., a polygon), even though such terms may occasionally be used interchangeably herein.

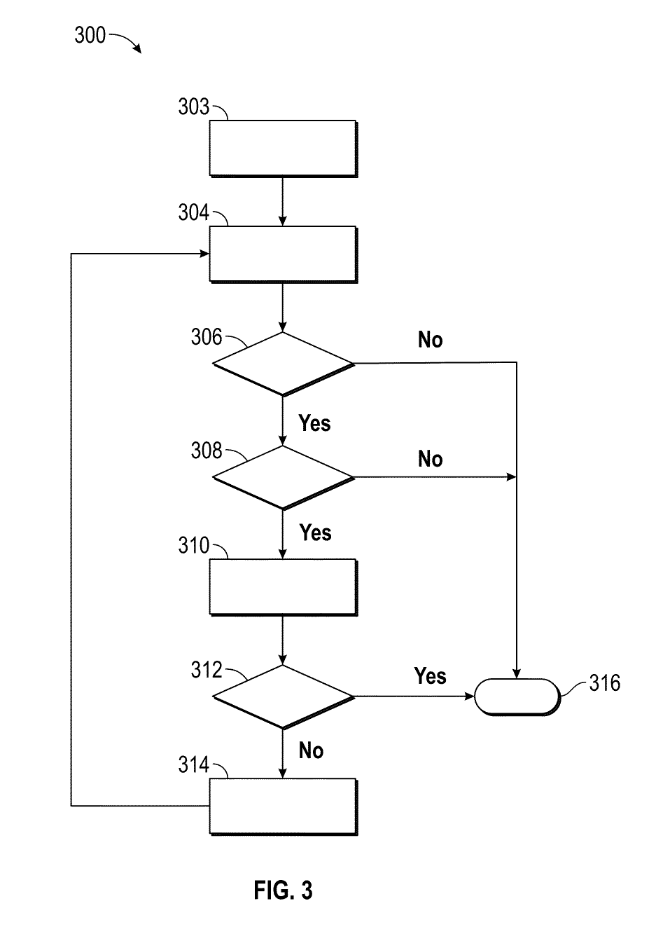

Referring now to the flowchart depicted in FIG. 3 in conjunction with the material resource 100 and parts 201-204 shown in FIG. 2, an exemplary method in accordance with one embodiment will now be described. While FIG. 3 does not itself include text corresponding to each step, in the interest of clarity, the individual steps can be read as follows: Approximate parts with inscribed circles (303); Solve nesting problem with approximated parts to get lower bound (304); Determine whether parts overlap in nest (306); Determine whether maximum penetration is less than a tolerance value (308); Attempt to eliminate overlap and update upper bound (310); Determine whether upper bound minus the lower bound is less than a tolerance value (312); Improve circle approximately (314), and Stop (316).

In general, as will be described in further detail below, the method includes approximating each of the parts 201-204 as the union of a corresponding set of inscribed circles (step 303), determining a minimum nest length associated with an optimal nest of the approximated parts on material resource 100 (step 304), and determining a final nesting arrangement of the plurality of parts by iteratively adding inscribed circles to the set of inscribed circles based on overlap of the parts and applying an optimizing criteria to the nesting arrangement resulting therefrom (steps 306-314).

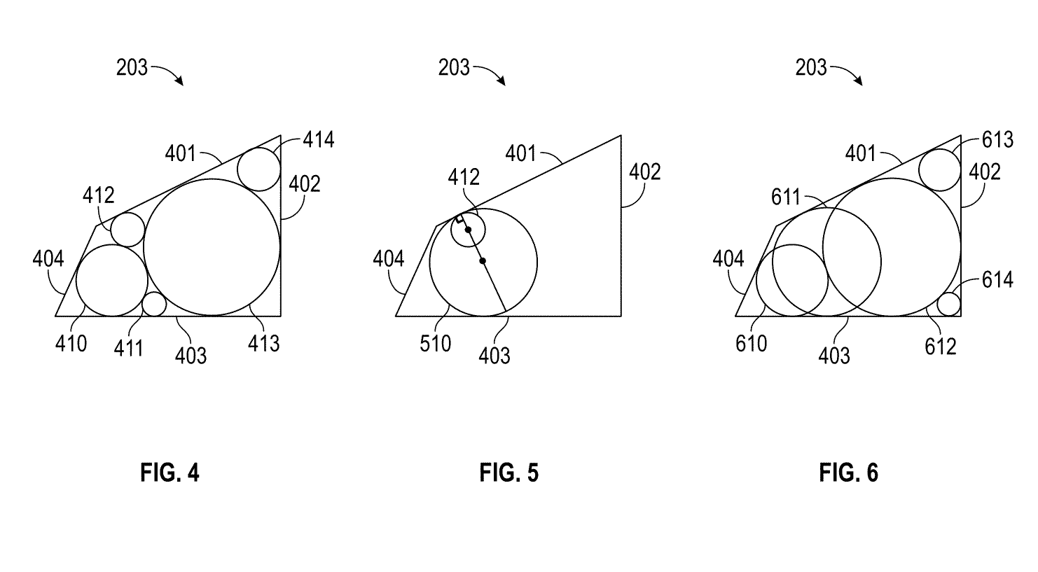

Step 303 includes approximating each of the parts as the union of a set of inscribed circles, and may be accomplished in a variety of ways. While the details of specific procedures will be described in further detail below, in one embodiment the procedure includes sequentially adding circles, at each step finding the largest circle that can be inscribed in the polygon that does not intersect any previously inscribed circle (e.g., via a triangular branch-and-bound method). In such an embodiment, the corresponding set of inscribed circles for each part will consist of non-overlapping circles. In other embodiments, however, the corresponding set of inscribed circles for each part may include overlapping circles. Examples of such approximations can be seen in FIGS. 4 and 6.

Specifically, FIG. 4 depicts part 203 enclosed by sides 401, 402, 403, and 404 and having five circles inscribed therein, namely: circles 410, 411, 412, 413, and 414. Note that circles 410-414 are “inscribed” in that none of them extend beyond the perimeter of part 203 defined by sides 401-404. Further note that none of the circles 410-414 overlap with each other. FIG. 6, in contrast, shows part 203 with five inscribed circles 610-614 having some level of overlap. That is, circle 611 overlaps both circles 610 and circle 612. FIG. 5 briefly depicts a method in which circle 412 of FIG. 4 is radially expanded (e.g., perpendicular to side 401) such that it touches at least two sides (401 and 403), thus corresponding to circle 611 in FIG. 6. Additional methods for inscribing such circles will be described in further detail below.

Regardless of the particular procedure used to inscribe circles within their respective parts, it is desirable that, as a first approximation, a reasonable number of circles are inscribed, as shown. That is, if shape 203 as depicted in FIG. 4 were to be approximated by single circle 413, the resulting approximation for the purpose of the illustrated method would be unsatisfactory and inaccurate. Conversely, if shape 203 were to be approximated by hundreds of circles, the resulting approximation would be unnecessarily granular and would lead to unsatisfactory computational complexity during subsequent processing. Accordingly, the number and configuration of initial inscribed circles may vary in any particular embodiment.

Step 304 includes determining a minimum nest length associated with a mapping of the sets of inscribed circles on to a geometric representation of the material resource 100, and may be performed in a variety of ways. In one embodiment, a global optimization procedure is used to determine the minimum nest length for the approximated parts. The variables in such a global optimization problem include: the nest length; the horizontal and vertical translations of each part from its predefined “reference position” (e.g., an arbitrary starting position in the plane) to its “nested position”; and any rotation of each part around a reference point (the angle is captured via its sine and cosine). The global optimization problem to be solved would thus have a linear objective function (the nest length) and many quadratic constraints. One set of quadratic constraints enforce the condition that circles inscribed in different parts must not overlap. The second set of quadratic constraints enforce the condition that the sum-of-squares of the sine and cosine of any rotation angle is one. The resulting problem structure has the advantage that it is solvable to guaranteed optimality by existing methods. Furthermore, because the approximated parts are smaller than (or contained within) the actual physical parts, this optimal minimum length is a lower bound on the nest length using the actual parts.

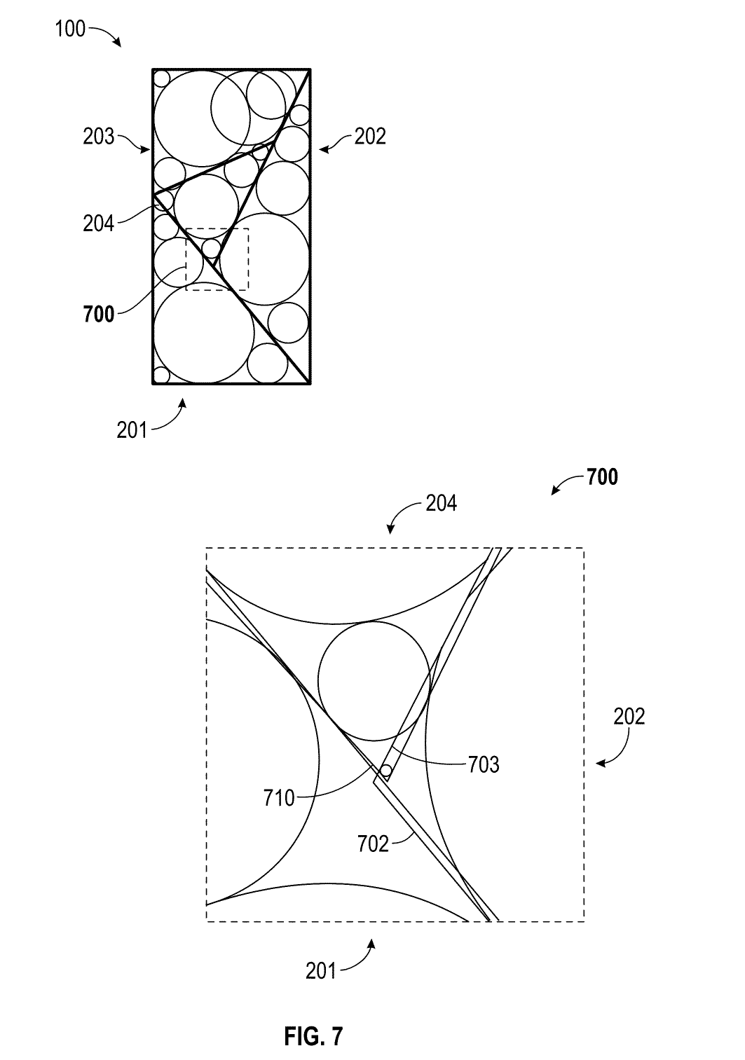

Continuing with the flowchart of FIG. 3, after the lower bound of the nest length is determined, in step 306 the system determines whether there is an area of overlap between two or more of the parts. That is, as will be appreciated, even if the inscribed circles from one part do not overlap the inscribed circles of another part, the parts themselves may overlap. This can be seen in FIG. 7, for example, which depicts shapes 201-204 (and corresponding inscribed circles, as shown) nested in a fairly efficient manner within material resource 100. Referring to the inset close-up view 700, however, it can be seen that part 204 overlaps slightly with part 202 (see line segments 703 and 702) as well as part 201. Circle 710 illustrates the largest circle that fits within the overlap area, as described in further detail below. Determination of this overlap region may be accomplished in accordance with a variety of standard computer-based geometrical techniques, and need not be described in further detail herein. If there is no overlap, the system continues to step 316 and terminates (having thus determined the optimum nesting arrangement). If there is overlap, the system continues with step 308.

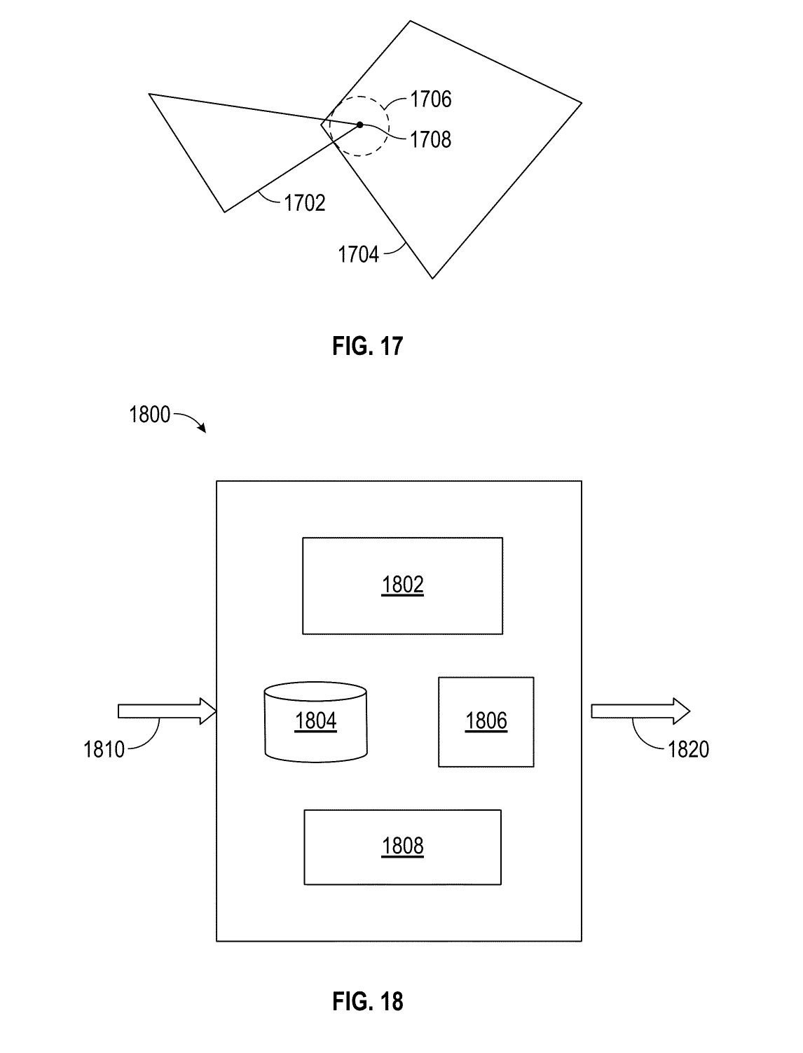

At step 308, the system determines whether the maximum penetration of one part into another is below a penetration tolerance value (just one way to quantify the level of overlap). If the maximum penetration is below the tolerance value, the system continues to step 316 and terminates. That is, the system contemplates there is typically some small level of overlap that is acceptable in many real-world applications. Computation of the maximum penetration may be measured in a variety of ways. Referring to FIG. 17, for example, a part 1702 overlaps with part 1704. The maximum penetration of part 1702 into part 1704 is defined as the radius of the largest circle that has a center point in part 1702 but lies entirely within part 1704. In this case, this largest circle is labeled 1706 and has center point 1708 from part 1702. It may be demonstrated by a person of skill in the art that convergence must occur (i.e., maximum penetration fall below a predefined tolerance) in a finite number of steps.

Referring again to FIGS. 3 and 7, the system next applies small perturbations to the position of at least one of the parts in an attempt to eliminate any overlap and obtain a valid nest of the original parts (i.e., no overlap). In FIG. 7, for example, the x and/or y position of shape 202 may be increased slightly to eliminate its overlap with part 204. A variety of heuristics and procedures may be used to accomplish this task. If this process succeeds in finding a non-overlapping solution, the system can consider terminating based on another criterion (step 312). In particular, if the difference between the valid non-overlapping nest length and the lower bound from step 304 is within some predefine tolerance, then the system continues to step 316 and terminates.

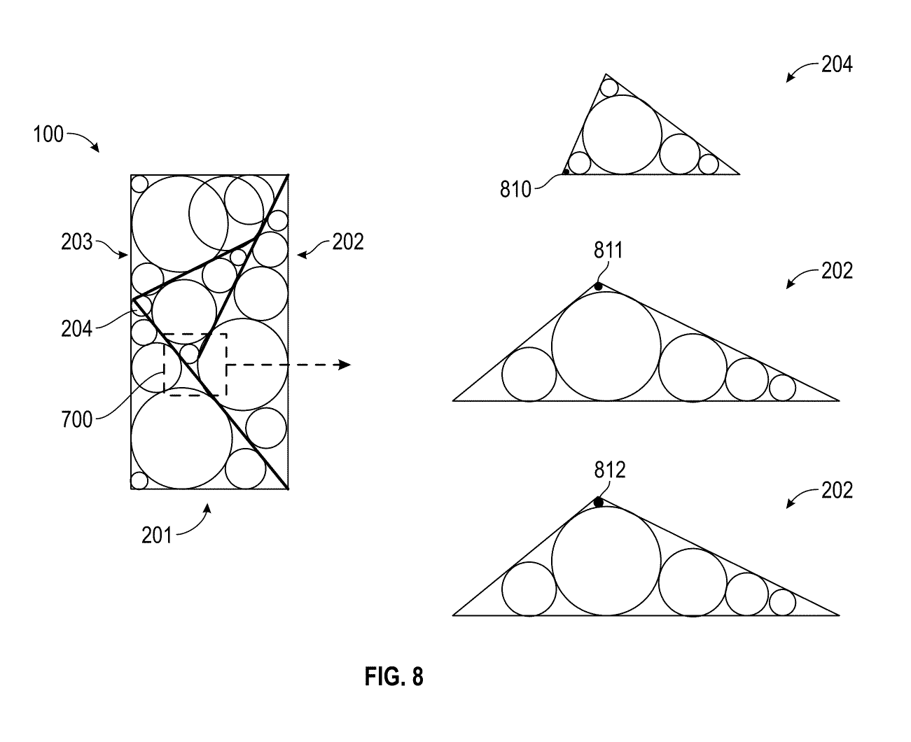

At step 314, the system attempts to improve the approximation of the parts. To do this, the system starts by finding largest circle fitting within the area of overlap of two or more parts. This is shown in FIG. 7, in which the largest circle in the overlap of two parts is denoted as circle 710. In FIG. 8, circle 710 has been mapped back to the two parts 202 and 204 that were overlapping in the nest. The mapped-back circles are labeled 810 and 811 in FIG. 8 (circle 810 is very small because the overlap is very small). Note that when these two new, mapped-back (and possibly grown) circles are added to parts 202 and 204, they would perfectly overlap in the nest depicted in FIG. 8 (left). Therefore, with this refinement, the overlapping nest of FIG. 8 would be infeasible in Step 304 in which the system solves the quadratic program (QP) to determine a lower bound. As a result, the lower bound in the subsequent iteration will usually increase. In this way the system slowly drives the lower bound higher until it is within a predefined tolerance of a known valid, non-overlapping nest. Also note that, if one of the mapped-back circles only touches one side of the polygon, the method of FIG. 5 can be used to “radially grow” the circle into a bigger circle that includes the mapped-back circle. An example is shown in FIG. 8, where circle 811 is grown to circle 812. Growing circles in this way further improves the circle approximation, because more of the polygon is covered by circles.

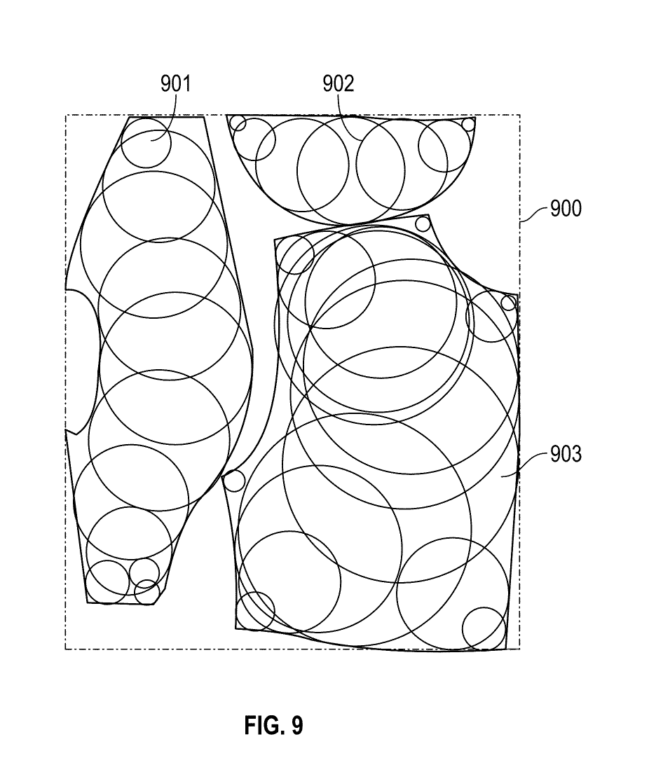

To illustrate a more complex case, FIG. 9 depicts another example in which three non-convex parts 901-903 are optimally nested within material resource 900. This is illustrative of the number of inscribed circles that are required to achieve convergence with such irregularly shaped parts.

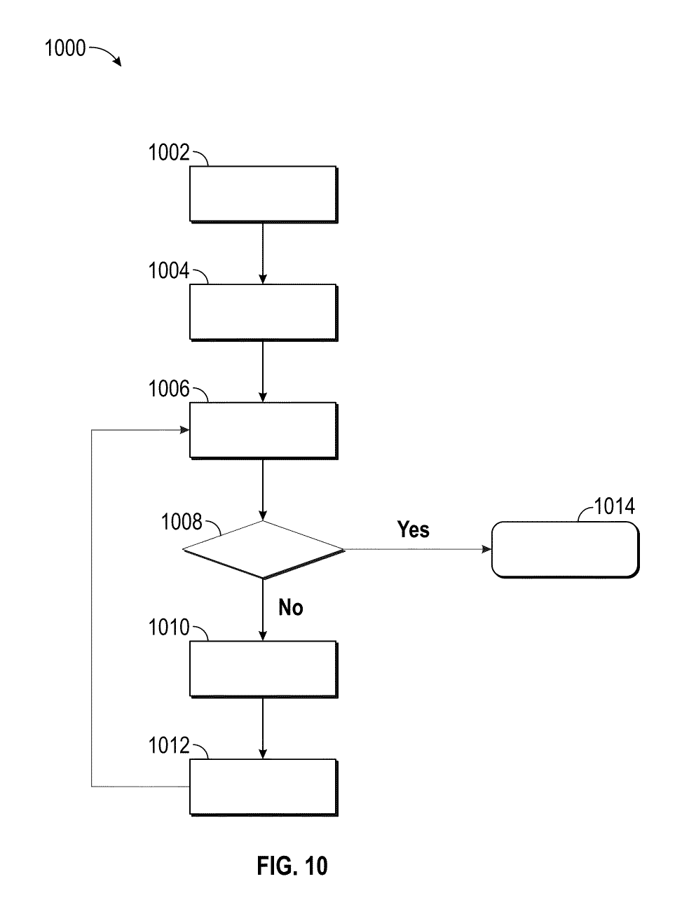

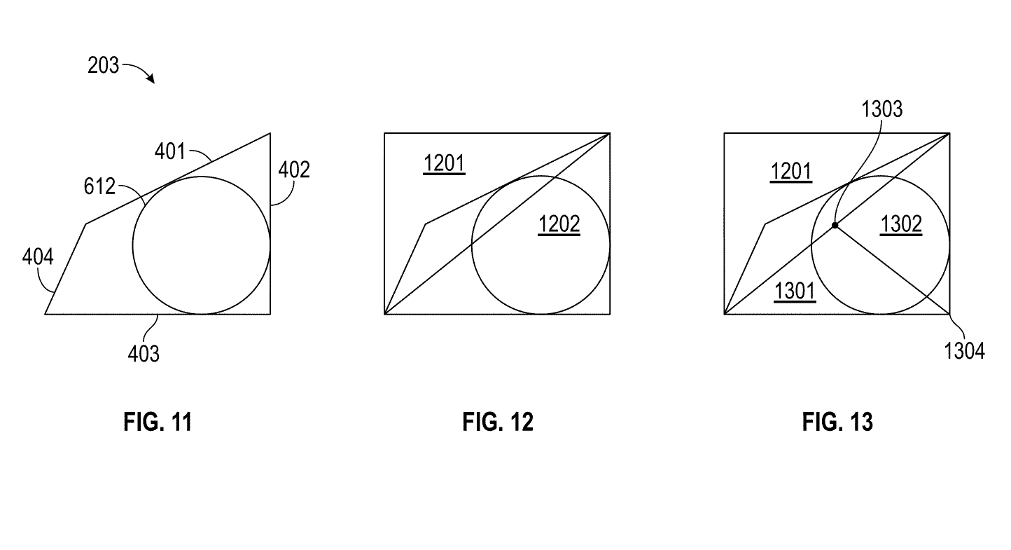

As noted above, a variety of methods may be used to provide the sets of inscribed circles (step 303 of FIG. 3). In that regard, FIG. 10 presents an exemplary “triangular branch-and-bound” method of inscribing circles, and can be understood in conjunction with the sequence of images shown in FIGS. 11-16, which depict part 402 and the triangular branch-and-bound method (1000) to find the largest circle that can be inscribed in the polygon without overlapping any previous inscribed circle.

While FIG. 10 does not itself include text corresponding to each step, in the interest of clarity, the individual steps can be read as follows: Provide a polygon with any number of inscribed circles (1002); Divide the polygon's bounding box into two triangles (1004); Compute lower and upper bounds for each triangle in partition (1006); Determine whether overall upper bound minus the overall lower bound is less than a tolerance (1008); Bisect triangle with highest upper bound along its longest side (1010); Delete any triangle in the partition that no longer intersects the part (1012); Stop and return center of triangle with the highest lower bound (1014).

The method begins with step 1002, which assumes that the system is presented with a polygon that may have any number of previously inscribed circles. Initially, of course, there will be no inscribed circle. FIG. 11 illustrates the case in which part 203 has just one previously inscribed circle (612). Next, in step 1004, the bounding box of part 203 is covered with two non-overlapping triangles (1201 and 1202) that together form a rectangle that encloses part 203 (FIG. 12).

In step 1006, for each triangle in the partition, the system computes a lower and upper bound on the radius of a circle that: (i) has a center in the triangle: (ii) lies within the polygon, and (iii) does not intersect any previously inscribed circles. In FIG. 15, for example, the system is computing the lower bound for triangle 1409. This begins by identifying the centroid of the triangle (1502). If the centroid lies inside the original polygon (which may not always be the case), the system computes the minimum distance from the centroid 1502 to each side of part 203 and to each inscribed circle (shown as dotted lines). The minimum of all these distances is the radius of the largest circle that can be inscribed having centroid 1502 as the center, and is thus the lower bound on the radius of an inscribed circle with a center anywhere in the triangle.

Computation of the upper bound for triangle 1409 is shown in FIG. 16. In this case, for each side of the polygon, the system determines which vertex is farthest from the side (dotted lines). Similarly, for each circle, the system computes the distance from the circle to the farthest vertex. The minimum of the distances is a valid upper bound on the radius of an inscribed circle with a center in the triangle that does not intersect any previously inscribed circles.

In step 1008, the system considers the difference between the overall lower bound (the largest lower bound of any triangle) and the overall upper bound (the smallest upper bound of any triangle). If the gap between these bounds falls below a predefined tolerance, the system stops (step 1014) and returns the largest inscribed circle found (the one giving the best lower bound). Otherwise, the system continues to step 1010.

In step 1010, the system selects the triangle with the largest upper bound and bisects it, creating two “child” triangles by connecting the midpoint of the longest side to the opposite vertex (step 1006). In FIG. 13, for example, triangle 1202 is subdivided into triangles 1301 and 1302 by a line extending from midpoint of the longest side (1303) to the opposite vertex (1304).

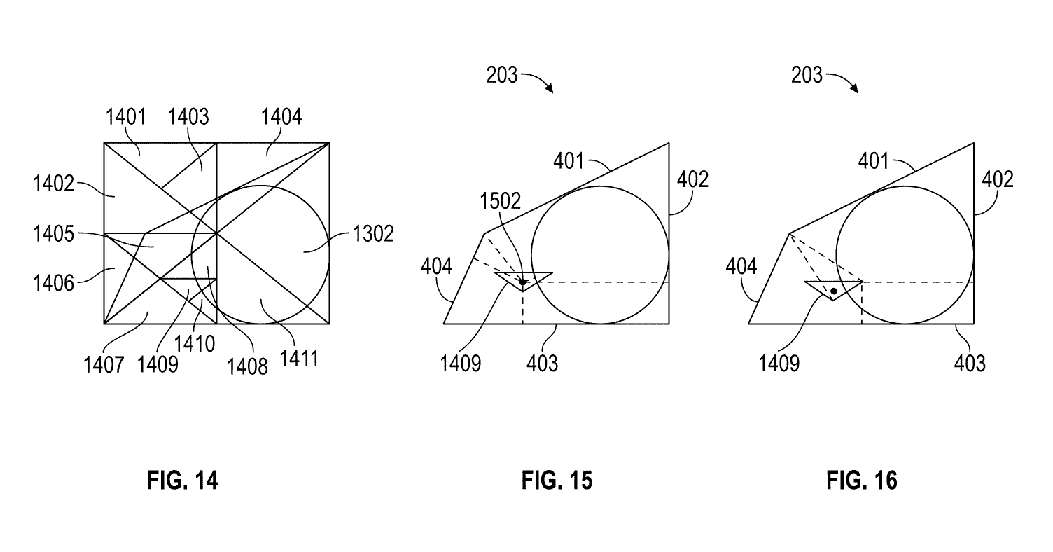

In step 1012, the system checks whether any triangle in the partition has an empty intersection with part 203; any such triangle is then deleted, as it cannot contain the center of any inscribed circle, let alone the largest one. In FIG. 14, for example, iterations have proceeded until there are twelve triangles: triangles 1302 and 1401-1411. Triangle 1401 does not intersect part 203, so it is deleted. At this point the system returns to step 1006 and iterates until convergence. Once convergence has occurred, the system will have added another circle to the approximation. If the system is allowing inscribed circles within a part to overlap, we can radially grow the new circle as shown in FIG. 5 (where circle 412 is grown into circle 510). Note that this growth will only be possible if the newly added circle only touches one side of the polygon. Finally, if more circles are desired, the entire procedure can be repeated.

FIG. 18 illustrates a nesting system 1800 in accordance with one embodiment, and generally includes a processor (microprocessor, controller, or the like), one or more storage devices (e.g., hard drives, etc.), memory (e.g., SDRAM, etc.) and a display (e.g., LCD or OLED display) 1802. System 1800 may include additional components (not shown) typically associated with, for example, a general purpose computer—such as various user interface components (mouse, keyboard, touchpad, etc.) and a network interface (e.g., Ethernet, WiFi, etc.). System 1800 accepts input data (1810) relating to the material resource and parts to be nested, and produces an output (1820) specifying the optimum nesting arrangement, as described above. System 1800 is configured to read non-transitory computer-readable media (e.g., embodied in storage 1804, memory 1806, CDROM, etc.) bearing software instructions configured to instruct processor 1808 to determine the optimal nesting arrangement. The optimal nesting arrangement may be stored (e.g., in storage 1804) as any suitable data structure, for example, a data structure including a mathematical representation of each part, the position and orientation of each part, and a mathematical representation of the material resource. The nesting arrangement may further be displayed graphically on display 1802 for user inspection, and may be accompanied by additional data associated with the optimal mapping (e.g., optimal nesting length, etc.)

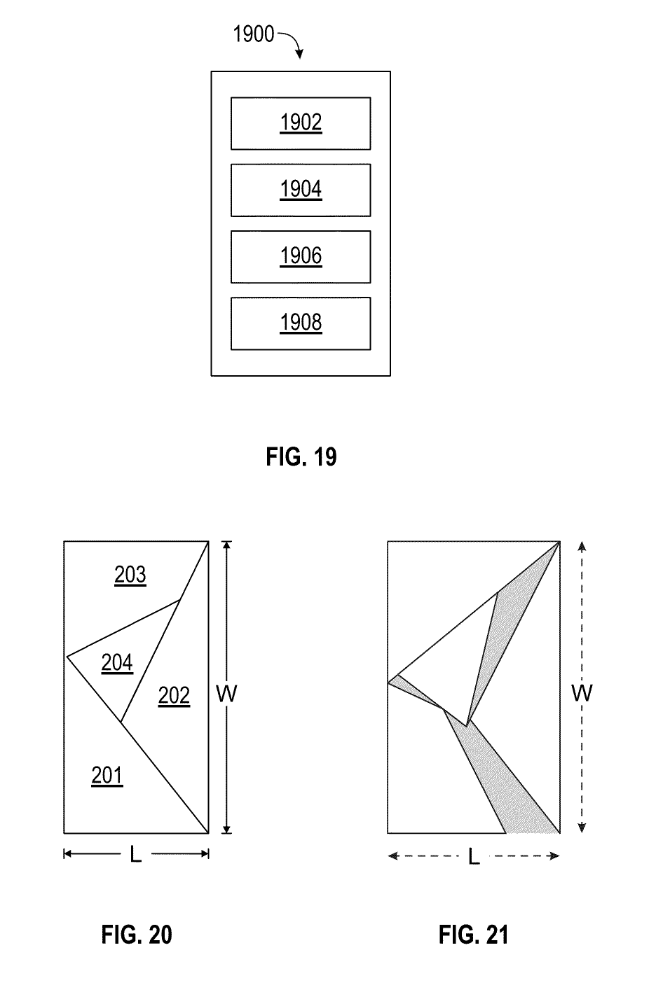

FIG. 19 depicts, conceptually, a modular nesting system 1900 in accordance with one embodiment, which may be implemented via the system of FIG. 18. As shown, system 1900 includes an initial approximation module 1902, a nest length optimization module 1904, an iterative refinement module 1906, and a convergence assessment module 1908. In general, initial approximation module 1902 includes any suitable combination of hardware and/or software configured to approximate each of the parts as the union of a set of inscribed circles, as described above. Nest length optimization module 1904 includes suitable hardware and/or software configured to determine a nest length associated with the optimal nesting of the approximated parts on the material resource. Iterative refinement module 1906 is configured to determine if the original (non-approximated) parts overlap in the nest and, if so, refine the inscribed-circle approximation by adding new inscribed circles based on overlap of the parts. Convergence assessment module includes any suitable combination of hardware and/or software configured to compute a metric used to determine whether the nest is optimal within a predefined tolerance.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of nesting a plurality of parts on to a material resource, the method comprising:
approximating each of the parts as a union of a set of inscribed circles;
determining, with a processor, an optimal nesting of the approximated parts on the material resource, wherein the optimal nesting allows both translations and rotations of the parts from a reference position
improving the approximated parts by adding inscribed circles based on overlap of the parts in the nest; and
iteratively determining the optimal nesting of the approximated parts and improving the approximated parts until the nested arrangement of the parts is optimal within a predefined tolerance.

2. The method of claim 1, wherein iteratively adding inscribed circles to the approximated parts includes:
determining the largest circle fitting within the overlap of any two parts in the nest; and
mapping the largest circle in the overlap area back to the reference position of the first part and the second part, and adding the mapped-back circle to the set of approximating circles for each part.

3. The method of claim 1, wherein a convergence criteria includes computing the maximum penetration of any one part into another part in the nested arrangement, and checking whether the maximum penetration is below a penetration tolerance value.

4. The method of claim 1, where small perturbations are applied to the position of the parts in the nest to eliminate overlap to obtain an upper bound on the nest length.

5. The method of claim 1, wherein the optimizing criteria includes determining whether a difference between a lower and upper bound on the nest length is less than or equal to a predefined convergence tolerance value.

6. The method of claim 1, wherein the corresponding set of inscribed circles for each part consists of non-overlapping circles.

7. The method of claim 1, wherein the corresponding set of inscribed circles for each part includes overlapping circles via radially growing circles that touch only one side of the polygon being approximated.

8. The method of claim 1, wherein approximating each of the parts as the union of several inscribed circles includes sequentially adding circles and finding the largest inscribed circle that does not intersect a previously inscribed circle.

9. The method of claim 8, wherein finding the largest circle that can be inscribed in a polygon without overlapping any pre-existing inscribed circle includes applying a triangular branch-and-bound method to each part.

10. The method of claim 1, wherein determining the optimal nest length associated for the circle-approximated parts involves applying a quadratic programming method.

11. The method of claim 1, wherein at least one of the parts is non-convex.

12. A system for nesting a plurality of parts on to a material resource, the system comprising:
an initial approximation module configured to approximate each of the parts as a union of a set of inscribed circles;
a nest length optimization module, including a processor, configured to determine a nest length associated with the optimal nesting of the approximated parts on the material resource;
an iterative refinement module configured to determine if the original non-approximated parts overlap in the nest and, if so, refine the inscribed-circle approximation by adding new inscribed circles to the approximated parts based on overlap of the parts; and
a convergence assessment module configured to determine whether a nesting of the parts is optimal within a predefined tolerance.

13. The system of claim 12, wherein the iterative refinement module is configured to:
determine if any two parts in the nest overlap; and
if two any two parts in the next overlap, then:
determine the largest circle that can be inscribed in the overlap of any two parts in the nest; and
map the largest circle in the overlap of any two parts back to the reference position of the first part and the second part, and add the mapped-back circles to the set of approximating circles.

14. The system of claim 13, wherein an optimizing criteria includes determining whether the maximum penetration between any two parts in the nest is below a penetration tolerance value.

15. The system of claim 13, wherein the optimization module is configured to apply small perturbations to the position of at least one of the first part and the second part to eliminate overlap if the maximum penetration is greater than or equal to a penetration tolerance value.

16. The system of claim 12, wherein the convergence criteria includes determining whether the difference between the lower and upper bound on the nest length is less than or equal to a convergence tolerance value.

17. The system of claim 12, wherein approximating each of the parts as the corresponding set of inscribed circles includes sequentially adding circles and finding the largest circle that does not intersect a previously inscribed circle.

18. Non-transitory computer-readable media bearing software instructions configured to instruct a processor to determine an optimal nesting arrangement for a set of parts on a material resource by:
approximate each of the parts as a union of a set of inscribed circles;
determine an optimal nesting of the approximated parts on the material resource;
improve the approximated parts by adding inscribed circles to the approximated parts based on overlap of the parts in the nest;
iteratively determine the optimal nesting of the approximated parts and improving the approximated parts until the nesting arrangement of the parts is optimal within a predefined tolerance.

19. The non-transitory computer-readable media of claim 18, wherein iteratively adding inscribed circles to the set of inscribed circles includes:
determining the largest circle than can be inscribed in the overlap of any two parts in the nest;
mapping the largest circle in the overlap of any two parts back to the reference position of the first part and the second part, and then adding the mapped-back circles to the set of approximating circles; and
radially growing the circles if they touch only one side of the part.

20. The non-transitory computer-readable media of claim 18, wherein approximating each of the parts as the corresponding set of inscribed circles includes sequentially adding circles and finding the largest circle that does not intersect a previously inscribed circle.
